(19) United States
(12) Patent Application Publication
(10) Pub. No.: US 2018/0020802 A1
(43) Pub. Date: Jan. 25, 2018

(54) A Tray For a Shaving Razor

(71) Applicant: Razorector Pty Ltd, Kalgoorlie (AU)

(72) Inventor: Paul Stephen Buckle, Kalgoorlie (AU)

(73) Assignee: Razorector Pty Ltd, Kalgoorlie (AU)

(21) Appl. No.: 15/547,403

(22) PCT Filed: Jan. 30, 2016
(86) PCT No.: PCT/AU2016/050053

§ 371 Date: Jul. 28, 2017

(30) Foreign Application Priority Data
Jan. 30, 2015 (AU) 2015900292

(51) Int. Cl. A45D 27/22; B65D 1/36; B65D 25/10; A45D 27/46

(52) U.S. Cl. CPC A45D 27/22; A45D 27/46; B65D 1/36; B65D 25/10; B08B 3/08

(57) ABSTRACT

The invention provides a razor storage tray in the form of an elongate tray body which includes a razor support for holding a razor handle in a generally horizontal position in the tray body, as well as a sump arranged relative to the support means, to retain a liquid at a level below blades of the razor when a handle of the razor is located on the support means.

### CROSS-REFERENCE TO RELATED APPLICATIONS

This application comprises a U.S. national stage entry of PCT/AU2016/050053 filed Jan. 30, 2016, the entirety of which is incorporated herein by reference.

### FIELD OF THE INVENTION

THIS INVENTION relates to a tray for a shaving razor. Specifically the invention relates to a tray for storing a razor when not in use.

### BACKGROUND OF THE INVENTION

A shaving razor is a hand tool having blades, and is used to remove unwanted hair. Modern razors often include a razor body and attachment means for attaching a replaceable blade. The blades are used for shaving until they are blunt and they are then replaced with a new blade. Corrosion of the blades, water calcifying on the blades and shaving debris, are all factors which contribute to the blunting of the blades. New blades are expensive and when blades have to be replaced frequently, it leads to excessive costs. The Applicant has identified a need for a tray for storing a razor, which will prolong the time that a blade can be used before having to be replaced. Throughout this specification the term “razor” refers to a shaving razor having a handle portion forming a neck and a head portion, the head portion holding the blades.

### SUMMARY OF THE INVENTION

According to once aspect of the invention, there is provided a razor storage tray, which includes

an elongate tray body;

razor support for holding a razor handle in a generally horizontal position, in the tray body; and

a sump arranged relative to the support, to retain a liquid at a level below the blades of the razor when a handle of the razor is located on the support.

The elongate tray body may be in the form of a dish. The dish may have raised sides. The dish may be of unitary construction. The dish may be made of one or more materials selected from any one or more of plastic, ceramic, porcelain, metal, and the like.

The razor support may be in the form of one or more elevated platforms provided in the tray body. A first platform may be operable to receive a neck portion of the razor.

The first platform may include a receiving formation, shaped and dimensioned to receive the neck portion of the razor. The receiving formation may releasably secure the neck portion of the razor to the platform, thereby securing the razor in a position such that the sump is located below the blades of the razor.

The first platform may be located substantially centrally in the tray body. In one embodiment the first platform may be adjustable. The first platform may be adjustable in any one or both of a vertical plane or a horizontal plane, thereby to accommodate a particular sized razor.

The razor support may include a second platform to receive a rear portion of the handle of the razor. In use, the rear portion of the handle may rest on the second platform. The second platform may be located towards a rear of the tray body.

In an embodiment in which the razor support includes the first and second platform, the platforms may be laterally spaced apart, in use allowing a razor to be spanned across the two platforms.

A space between the two platforms may define a recessed surface. In one embodiment the recessed surface may define a receptacle between the two platforms, which may be filled with a cleaning liquid. The cleaning liquid may be in the form of water. In use, a blade of the razor may be cleaned in the receptacle, between shaving stokes. The recessed surface also serves as a catchment area for any water droplets from a user's hand after shaving and when stowing the razor.

The recessed surface may include a decorative zone. The decorative zone may include any one or both of decorations and advertising. The advertising may be in the form of Trademarks, names, slogans, logos or the like.

In one embodiment the elongate tray body and razor support may be of unitary construction.

The liquid may be in the form of a blade-preserving liquid. The liquid may be in the form of an anti-oxidating liquid. Specifically, the liquid may be in the form of oil. The oil may be in the form of any one or more of olive oil, aloe oil, Vitamin E oil, tea tree oil, and the like. The liquid may include any one or more of a fragrance, colour and scent.

In use, a blade of the razor may be suspended above the liquid in the sump.

The sump may include a raised perforated screen. In use, the sump may be filled with the liquid such that the liquid extends above the screen. In use, shaving debris and the like will sink below the raised screen, leaving clean liquid above the screen. The sump may be located in front of the first platform. The raised perforated screen may be of stainless steel. The raised perforated screen may be removable from the sump.

The razor storage tray may include a blade cleaning pad holder. The razor storage tray may include a blade cleaning pad. The blade cleaning pad may be in the form of a sponge pad. The blade cleaning pad may be removably secured in the blade cleaning pad holder. The blade cleaning pad may be disposable. The blade cleaning pad holder may be located towards a front of the tray body.

The blade cleaning pad may be used to remove excess preserving liquid and shaving debris from blades of the razor prior to shaving.

The razor storage tray may further include a cover, attachable to the tray body. The cover may be in the form of a lid shaped and dimensioned to fit onto the tray body. The cover may be of any one of plastic, ceramic or the like. The cover may include a handle. The handle may be shaped as a novelty item. The cover may include a decorative zone. The decorative zone may include any one or both of decorations and advertising. The advertising may be in the form of Trademarks, names, slogans, logos or the like.

The elongate tray body may define a shape outline in plan view. The shape may be in the form of any one of a figurine, a novelty shape, or the like, such as the outline of a man or a woman, a vehicle or a sports team logo. The elongate tray body may include feet, for supporting the tray body on a surface on which it may be stood. The feet may be of a non-slip material or comprise a non-slip coating to ensure sufficient purchase of the tray on the surface, so that it does not readily slide or move when used by a user.

The one or more platforms may include decorative features provided on the platform. The decorative features may be in the form of any one or more of mosaic, tiling, patterns, logos, diamantes, buttons, raised shapes and the like.

The invention will now be described, by way of example only, with reference to the following drawing(s):

### DRAWING(S)

In the drawing(s):

FIG. 1 shows a three-dimensional view of a razor storage tray in accordance with one embodiment of the invention.

FIG. 2 shows a top view of another shaped razor storage tray.

FIG. 3 shows a side view of the razor storage tray of FIGS. 1 and 2, in use.

In the drawings, like reference numerals denote like parts of the invention unless otherwise indicated.

### EMBODIMENT OF THE INVENTION

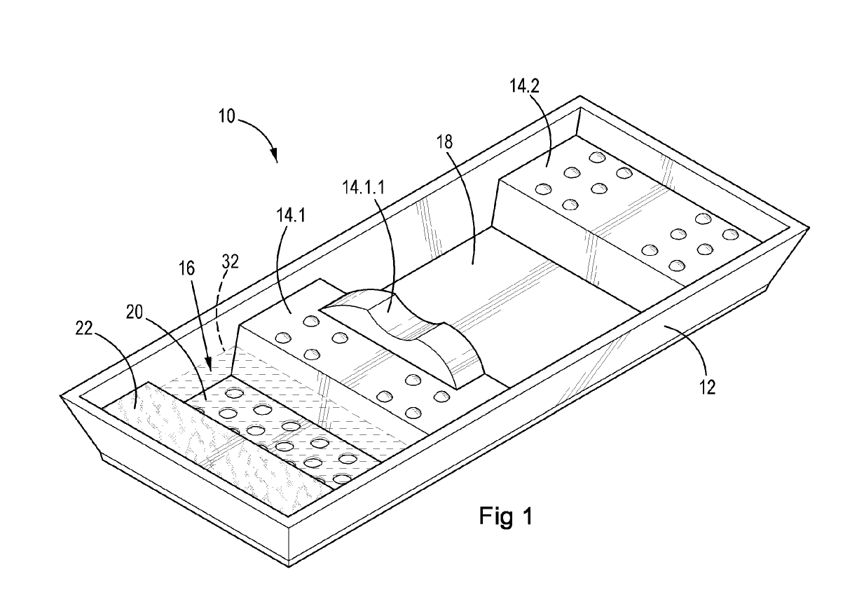

In FIGS. 1, 2 and 3, reference numeral 10 refers to a razor storage tray in accordance with one embodiment of the invention. The razor storage tray 10 includes an elongate tray body 12, razor support 14 for holding a razor handle 50.1 in a substantially horizontal position in the tray body 12, and a sump 16 arranged relative to the support 14, to retain a liquid 32 at a level below blades 50.3 of the razor 50 when a handle 50.1 of the razor is located on the support.

The elongate tray body 12 is in the form of a dish having raised sides. In this example the dish is made of a high-density plastics material. The inner and outer surface of the dish are coated with PTFE (Teflon®) to ensure that it the dish is easy to clean and that shaving debris does not readily stick to outer or inner surfaces thereof.

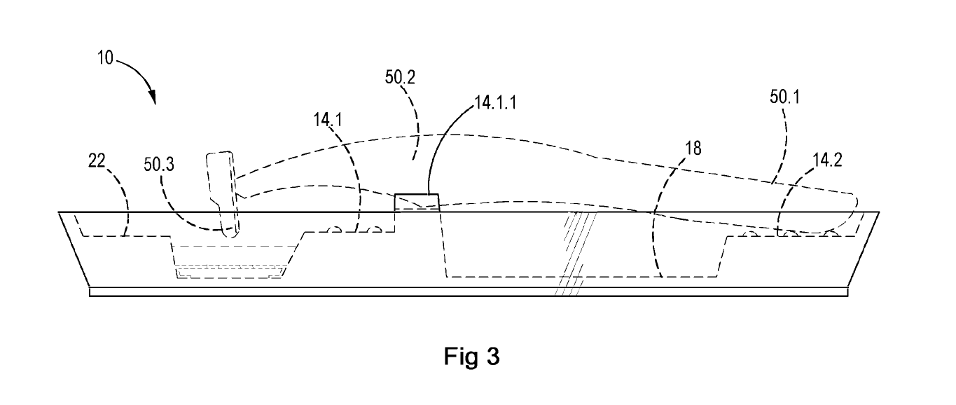

In this example the razor support 14 is in the form of two elevated platforms 14.1, 14.2 provided in the tray body 12. As shown in FIG. 3, the first platform 14.1 is operable to receive a neck portion 50.2 of the razor 50. The first platform 14.1 includes a receiving formation 14.1.1, shaped and dimensioned to receive the neck portion 50.2 of the razor. The receiving formation 14.1.1 holds the razor 50 in a position such that the sump 16 is located below the blades 50.3 of the razor. The first platform 14.1 is located substantially centrally in the tray body 12.

The second platform 14.2 is operable to receive a rear portion 50.1 of the handle of the razor 50. In use (as shown in FIG. 3), the rear portion 50.1 of the handle rests on the second platform 14.2. As shown, the second platform 14.2 is located towards a rear of the tray body 12.

The platforms 14.1, 14.2 are laterally spaced apart, in use allowing the razor 50 to be spanned across the two platforms 14.1, 14.2. A space between the two platforms 14.1, 14.2 define a recessed surface 18. The recessed surface 18 defines a receptacle between the two platforms 14.1, 14.2, which can be filled with a cleaning liquid (not shown). Specifically the cleaning liquid is in the form of water, although it may also be an organic solvent such as an alcohol or an alcoholic solution. In use, a blade 50.3 of the razor 50 is cleaned in the receptacle, between shaving stokes. The recessed surface 18 includes a decorative zone (not shown), which includes a name and logo.

The sump 16 includes a raised perforated screen 20. In use, the sump 16 is filled with the liquid 32 such that the liquid 32 extends above the screen 20. In use, shaving debris and the like will sink below the raised screen 20, leaving clean liquid above the screen 20. As shown, in this example the sump 16 is located in front of the first platform 14.1. In this example the raised perforated screen 20 is of stainless steel and is removable. In another embodiment, the raised perforated screen 20 is of stainless steel and is coated with PTFE (Teflon®) to ensure that shaving debris does not readily stick to it.

The liquid 16 is in the form of a blade preserving liquid. Specifically, the liquid 16 in the form of anti-oxidating liquid, preferably olive oil. The oil includes a fragrance. In another embodiment, the oil is an oil having antibacterial activity, such as tea tree oil.

In use, the blade 50.3 of the razor is suspended above the liquid in the sump 16 when placed upon the platforms 14.1, 14.2.

The razor storage tray 10 further includes a blade cleaning pad holder for receiving a blade cleaning pad 22. The blade cleaning pad 22 is in the form of a sponge pad. The blade cleaning pad 22 is removably secured in the blade cleaning pad holder. The blade cleaning pad 22 is disposable. The blade cleaning pad holder is located towards the front of the tray body 12. The sponge is a synthetic sponge and is coated with an antimicrobial coating, such as an impregnated antibacterial, antifungal, and/or antiviral composition.

The blade cleaning pad 22 is used to remove residual liquid and shaving debris from blades 50.3 of the razor 50 prior to each shave.

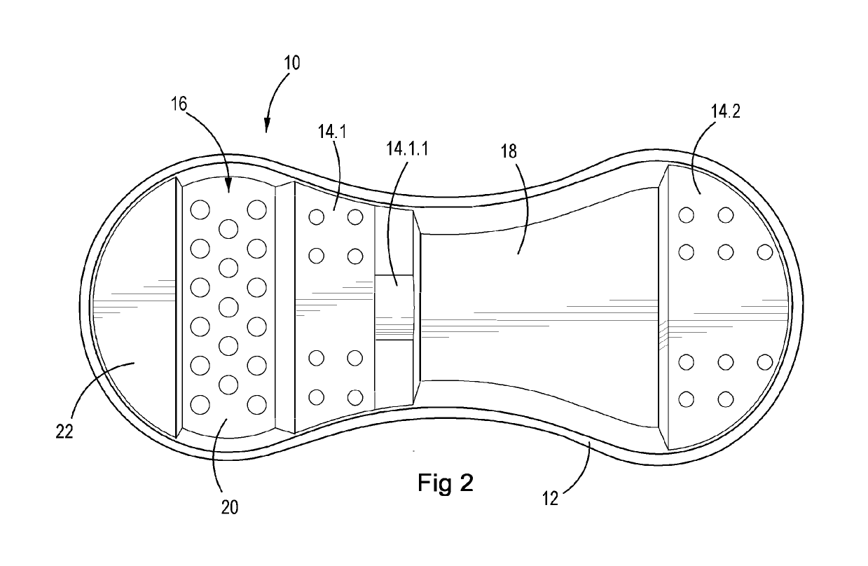

The elongate tray body 12 defines a shape outline in plan view. In FIG. 1 the shape is in the form of a rectangle, and in FIG. 2 the shape is curved or ellipsoidal.

In this example both platforms 14.1, 14.2 include decorative features provided on the platforms. The decorative features are in the form of diamantes.

In order to use the razor storage tray 10, a user will fill the sump 16 with the oil 32, the blades 50.3 of the razor are dipped in the sump 16, and the razor 50 is then stored horizontally on the razor support 14. When the user requires the razor 50, the razor 50 is lifted from the support 14, and the blades 10.3 are wiped on the blade cleaning pad 22 to remove excess oil, and the razor 50 is then used to shave. After shaving, the blades 50.3 of the razor 50 are rinsed in water, and excess water is shaken off. The blades 50.3 are again dipped in the sump 16 to contact the blades 50.3 with the oil 32. The razor 50 is then stored horizontally on the razor support 14, allowing the oil to preserve the blades until the next use.

The Applicant is of the opinion that he has invented a shaving tray which allows a user to maintain the overall condition of shaving blades for a longer period of time than without the shaving tray of the invention. This is achieved without excess wastage of water or oil, and without the handle or blades of the shaving razor being unnecessarily coated with excess oil or water.

1. A razor storage tray, which includes:
an elongate tray body;
a razor support for holding a razor handle in a generally horizontal position, in the tray body; and
a sump arranged relative to the support, to retain a liquid at a level below blades of the razor when a handle of the razor is located on the support.

2. The razor storage tray of claim 1, wherein the elongate tray body is in the form of a dish.

3. The razor storage tray of claim 2, wherein the dish has raised sides.

4. The razor storage tray of claim 2, wherein the dish is of a material selected from any one or more of plastic, ceramic, porcelain, metal and the like.

5. The razor storage tray of claim 1, wherein the razor support is in the form of one or more elevated platforms provided in the tray body.

6. The razor storage tray of claim 5, wherein a first platform is operable to receive a neck portion of the razor.

7. The razor storage tray of claim 6, wherein the first platform includes a receiving formation, shaped and dimensioned to receive the neck portion of the razor.

8. The razor storage tray of claim 7, wherein the receiving formation can releasably secure the neck portion of the razor to the platform, thereby securing the razor in a position such that the sump is located below the blades of the razor.

9. The razor storage tray of claim 5, wherein the first platform is located substantially centrally in the tray body.

10. The razor storage tray of claim 6, wherein the first platform is adjustable.

11. The razor storage tray of claim 10, wherein the first platform is adjustable in any one or both of a vertical or a horizontal plane, to accommodate a particular sized razor.

12-16. (canceled)

17. The razor storage tray of claim 5, wherein the tray body includes a decorative zone.

18. The razor storage tray of claim 17, wherein the decorative zone includes any one or both of decorations or advertising.

19. The razor storage tray of claim 1, wherein the elongate tray body and razor support are of unitary construction.

20. The razor storage tray of claim 5, wherein the liquid is in the form of a blade-preserving liquid.

21. The razor storage tray of claim 20, wherein the liquid is in the form of an anti-oxidating liquid.

22. The razor storage tray of claim 21, wherein the liquid is in the form of an oil.

23. The razor storage tray of claim 22, wherein the oil is selected from any one or more of olive oil, aloe oil, Vitamin E oil, or tea tree oil.

24. The razor storage tray, of claim 20, wherein the liquid includes any one or more of a fragrance, colour and scent.

25. The razor storage tray of claim 1, wherein the sump includes a raised perforated screen.

26-28. (canceled)
